(19) United States
(12) Patent Application Publication
(10) Pub. No.: US 2007/0054578 A1
(43) Pub. Date: Mar. 8, 2007

(54) Textile product with improved abrasion resistance and process for the production thereof

(76) Inventors: Werner Hoersch, Viersen-Boisheim (DE); Oliver Friedrichs, Monchengladbach (DE)

Correspondence Address: MILLIKEN & COMPANY, PO BOX 1926, SPARTANBURG, SC, 29303, US

(21) Appl. No.: 10/539,187

(22) PCT Filed: Dec. 15, 2003
(86) PCT No.: PCT/EP03/14242

§ 371 Date: Apr. 3, 2006

(30) Foreign Application Priority Data
Dec. 18, 2002 (DE) 102 59 284.5
Jan. 10, 2003 (DE) 103 00 684.2
Sep. 9, 2003 (DE) 103 41 587.4

(51) Int. Cl. B32B 27/12; B32B 27/04; B32B 5/02

(52) U.S. Cl. 442/148

(57) ABSTRACT

The invention relates to a textile product in which a three-dimensional pattern is applied on a textile substrate having a certain abrasion resistance, whereby the three-dimensional pattern covers at least 15% of the area of the textile substrate, so that the abrasion resistance of the textile product lies beyond the abrasion resistance of the textile substrate. As a consequence, the abrasion resistance of a textile substrate can be improved by a process in which a textile substrate web having a certain abrasion resistance is provided and a three-dimensional pattern covering at least 15% of the area of the textile substrate web is applied thereupon.

### TECHNICAL FIELD

The present invention relates to a textile product with improved abrasion resistance and a process for the production thereof. The textile product can be used in particular in the field of the automotive industry and in particular in the fields of interior lining, trunk, seat upholstery and the like.

### STATE OF THE ART

In the automotive industry but also in the textile industry as well as in other fields, textile products are used in manifold ways, which are subject to high requirements as to the abrasion resistance. Thus, for instance, those areas of the interior of a motor vehicle which frequently come into contact with the passengers are subject to increased exposure. As a consequence, the textile products used in these areas must comply with the requirements made to the abrasion resistance of the different producers. A common test to determine the abrasion resistance constitutes the Martindale process (DIN EN ISO 12947-1 to 4) which will be described in more detail below.

From EP 0 241 127 A2, for instance, it is known that the chemical composition of the fibers used for the textile product and their mechanical arrangement in the textile product are contributory factors of the qualities of the textile product. In particular, the polymer bonding agents used in the production of the textile fibers influence one or several physical qualities of the textile substrate. For instance, such bonding agents are used to improve deformation resistance, abrasion resistance, resistance to scrubbing and the physical and chemical stability of the textile product. Therefore, the abrasion resistance of a textile product consisting of a textile substrate can be increased by a corresponding choice of the polymer bonding agent.

Furthermore, DE 198 194 00 A1 discloses an improvement of the abrasion resistance of a cover fabric in that threads of increased thread size are made of an abrasion-resistant fiber material (preferably polyester) and threads of a lower thread size are made of a humidity-absorbing fiber material, e.g. wool, cotton, viscose stable fiber and the like. Thereby a sufficiently high degree of abrasion resistance of the cover fabric is achieved, since the stronger threads are exposed to higher abrasion strain and the less exposed thin threads which serve to absorb humidity are mechanically stressed or strained to a much lesser degree.

Therefore, from the state of the art there are known textile products in which the abrasion resistance of the textile product is increased by means of the chemical composition and/or the mechanical arrangement of the fibers in the textile substrate.

### DISCLOSURE OF THE INVENTION

The present invention is based on the object to provide both a process by which the abrasion resistance of a textile substrate can be improved independently of the chemical composition and the mechanical arrangement of the fibers, and a product produced accordingly.

In accordance with the invention, the object is solved by a textile product comprising
a textile substrate having a certain abrasion resistance; and
a three-dimensional pattern applied upon the textile substrate, whereby
the three-dimensional pattern covers at least 15% of the area of the textile substrate, so that the abrasion resistance of the textile product lies above the abrasion resistance of the textile substrate;
and/or
by a process for the production of a textile product with an improved abrasion resistance, comprising the steps of
   providing a textile substrate web having a certain abrasion resistance; and
   applying a three-dimensional pattern on the textile substrate web, which covers at least 15% of the area of the textile substrate web, so that the abrasion resistance of the textile product lies above that of the textile substrate web.

The textile substrate is preferably a textile substrate having a gsm substance of 50 g/m² to 500 g/m², in particular preferably 100 g/m² to 450 g/m². In this connection, textile substrates can be used in the form of wovens, warp-knitted fabrics, weft-knitted fabrics, non-wovens or Raschel goods which are preferably smooth or flat. Unpatterned fabrics and fabrics woven by shafts or jacquard-patterned flat basic fabrics are especially suited. Especially preferred are unpatterned woven fabrics. Furthermore, suitable woven fabrics should not have a floating longer than 8 warp threads and/or 8 weft threads on the surface. Especially preferred are woven fabrics having a floating of no longer than 5 warp threads and/or 5 weft threads. In this connection, the woven fabrics may be one-layered or multi-layered woven fabrics, with one-layered fabrics being especially preferred. Finely patterned or unpatterned knitted fabrics are especially preferred. Furthermore, the textile substrate is preferably machine-produced on single or double bar as well as on single or double jersey.

The yarns used are preferably flat or textured (e.g. those textured by a false twisting process) polyester endless filaments, preferably in the range of 33 dtex to 3.000 dtex, in particular preferably 45 dtex to 1.200 dtex. With the exception of polypropylene all of the other yarn materials are also suited in principle.

Although it is preferred according to the invention that the three-dimensional pattern is directly applied to the woven, the warp-knitted fabric, the weft-knitted fabric, the non-woven or the Raschel good, the textile substrate may further contain a coating which completely covers the textile. As a rule, this coating consists of a suitable polymer, for example a coating on the basis of polyurethane or polyurethane copolymers, acrylate, EVA and mixtures of polymers may be concerned. The polymers may be applied to the textile as stable or meta-stable foams or as pastes. Preferred are polyurethane coatings, in particular stable polyurethane foams.

As a rule, a dispersion of an ionomeric polyurethane on the basis of water is used for the production of the foamed polyurethane dispersion which may contain a foam stabilizer, as is, for example described in WO 94/06852. The polyurethane dispersions preferably have a solid content of 30 to 70% by weight, in particular 32 to 60% by weight. The term “polyurethane” also comprises polyurethane polyurea. A survey of polyurethane (PUR) dispersions may be taken from “Rosthauser und Nachtkamp, Waterborne Polyurethane, Advances in Urethane Science and Technology, vol. 10, pages 121 to 162 (1987)”. Suitable dispersions are e.g. also described in “Kunststoffhandbuch”, vol. 7, 2^{nd} ed. Hanser, pages 24 to 26. According to the invention, preferably used PUR dispersions include Tubicoat, PRV, Tubicoat M8 (producer/supplier each: CHT R. Beitlich GmbH, Tübingen) and the temperable polymer systems described in WO 94/06852.

The polyurethane dispersion preferably contains a foam stabilizer (e.g. the product Tubicoat Stabilisator RP (supplier: CHT R. Beitlich GmbH, Tübingen, Germany), pigments, ammonia, fixing agents, flameproofing agents thickeners, emulgators and/or light-stability agents, as they may also be used for the three-dimensional pattern.

The dispersion regularly contains plasticizers, which also determine the abrasion resistance of the coating. According to the invention, a relatively high amount of plasticizers may be used since the abrasion resistance is significantly determined by the three-dimensional pattern which is applied to the stable foam. As plasticizers, the substances may be used which are indicated in A. K. Dolittle, “The Technology of Solvents and Plasticizers”, J. Wiley & Sons Ltd. Preferably, polymeric plasticizers are used, e.g. Tubicoat MV (obtainable by CHT R. Beitlich GmbH, Tübingen) and Millitex PD-92 (Milliken, USA).

Prior to application, the polyurethane dispersion is foamed onto the textile substrate, as a rule, this is carried out mechanically. This may be performed in a foam mixing device at high shearing forces. A further possibility consists in that foaming is performed in a foam generator by blowing-in compressed air. Preferably, a Stork mixer or a foam processor, for example the Stork FP3 foam processor, is used. Foaming is carried out such that the foam density obtained preferably ranges from 150 to 280 g/l and particularly preferred it ranges from 180 to 220 g/l.

The foam obtained in this manner is stable, i.e. it does not decompose after application to a liquid but remains in the form of a foam on the textile substrate.

The coating process with the stable foam is carried out by a foam application system by means of knife-roll coaters, air blades, variopresses or, preferably, by an open squeegee with screen printing (Stork Rotary Screen Coating UNIT CFT). As a rule, the foam thickness after the application is between 0.4 and 0.8 mm, preferably between 0.5 and 0.6 mm.

Thereafter, the polyurethane foam-substrate composite obtained is dried, which is, as a rule, performed at a temperature of 80 to 150° C., preferably 100 to 130° C. If the textile substrate was expanded prior to the application of the PU foam, it is preferred to carry out drying onto an aggregate which allows a free shrinkage of the polyurethane foam-substrate composite, for example by means of a loop drier or a web drier (screen belt drier).

The polyurethane foam is then compressed with the substrate applying high pressure. This pressing can e.g. be carried out on a pressing apparatus, such as e.g. a calender, at a temperature range from 20 to 80° C., preferably 100 to 180° C. and a line pressure of 10 to 60 t or on a fixing unit, such as the Supercrab GCP 1200 (m-tec Maschinenbaugesellschaft mbH, Viersen), at a temperature from 100 to 160° C., preferably 135 to 145° C., and at pressures of 10 to 200 bar, preferably 120 to 180 bar. The foam is thereby compressed (e.g. from a foam thickness of 0.6 to 0.2 to 0.4 mm) and the adhesion between foam an textile substrate is thereby secured.

During compression, the polyurethane may already completely or partially condensate-out. If no sufficient condensating-out could be obtained during compression, the composite is subsequently sufficiently heated, e.g. to 140 to 180° C., preferably 170 to 180° C., in order secure a sufficient condensating-out of the polyurethane foam. This condensating-out may be performed on a tenter frame, so that tentering is performed at the same time and the product is brought to its final size.

The textile substrate—with or without coating—preferably has an abrasion resistance usually not sufficient for the application in the interior of motor vehicles, e.g. seat middle web or seat sides. Said abrasion resistance can be determined according to the Martindale process (DIN EN ISO 12947-1 to 4).

A textile substrate is regularly not suited for the application in the interior of a motor vehicle and thus is preferred as textile substrate in accordance with the invention, if at least one of the following criteria has not been complied with:

a) The textile substrate material used is preferably a textile, the mass loss of which is more than 0.03 g, preferably more than 0.05 g of the textile sample in an abrasion test after 50.000 Martindale abrasion cycles. That is to say a circular textile sample of the textile substrate having a diameter of 38 mm, such as required in DIN EN ISO 12947-3 (December 1998), is weighed before the beginning of the Martindale process. Upon termination of the abrasion test, i.e. after 50.000 Martindale abrasion cycles the sample is weighed again, so that the difference between the two indications of weight provides for the mass loss. Subsequently, the sample is subjected to an abrasion test of 50.000 abrasion cycles. In this connection, the circular sample is moved under a defined load against an abrasion agent (e.g. standard fabric) in a translatory manner approximately in the form of a Lissajous figure. The load weight used is the large 795 g+/−7 g mounting weight. An abrasion cycle further results from a revolution of the two outer gears of the Martindale testing apparatus. The abrasion agent used is a flat woollen fabric having a diameter of at least 140 mm and corresponding to the requirements of DIN EN ISO 12947-1 tab. 1.

b) As an alternative a textile is preferably used as a textile substrate material, in which destruction of the sample after 50.000 Martindale abrasion cycles (determined according to DIN EN ISO 12947-2 (December 1998)) is observed. In the case of wovens destruction occurs when two threads have been destroyed completely; in the case of knitted fabrics when one thread has been destroyed, which produces a hole; in the case of non-wovens when the diameter of the first hole produced by abrasion is at least 0.5 mm.

c) As an alternative a textile is preferably used as a textile substrate material, in which pilling is observed on a sample after 50.000 Martindale abrasion cycles. Whether pilling occurs after 50.000 Martindale abrasion cycles, can be observed after 25.000 abrasion cycles as compared to the same textile substrate: If a clear change is visible to the naked eye after 50.000 abrasion cycles as against 25.000 abrasion cycles, e.g. pills occurring on the surface, the textile substrate does not comply with the corresponding criterion and is preferred as textile substrate in accordance with the invention.

Especially preferred as substrates to be used according to the invention are wovens which do not comply with criterion a) and/or criterion b) and non-wovens which do not comply with criterion c).

A three-dimensional pattern is applied on said textile substrate, whereby said three-dimensional pattern covers at least 15% of the area (of one side) of the textile substrate, so that the abrasion resistance of the final product, i.e. the textile product, lies above the abrasion resistance of the textile substrate. The abrasion resistance of the end product will be above the abrasion resistance of the textile substrate, if either the mass loss is lower than in the textile substrate as such (cf. criterion a)), in contrast to the textile substrate as such no destruction is observed (cf. criterion b)), or in contrast to the textile substrate as such no pilling is observed (cf. criterion c)).

Preferably 25% of the area of the textile substrate is covered by the three-dimensional pattern, an especially preferred range being from 25% to 50%, even more preferred from 30% to 40%.

A three-dimensional pattern of the above kind is understood to be a pattern which raises from the textile substrate, that is to say one that has a three-dimensional shape. For this reason, it does not solely pertain to a colour pattern printed on but to a pattern which has a certain volume depending on the type of pattern, such as will be described below. Furthermore, coating of the entire area is not to be understood by the term three-dimensional pattern, because thus no pattern would be recognisable any more. Therefore, 100% of the textile substrate cannot be covered.

The three-dimensional pattern can be of a regular or irregular arrangement of the same or different geometrical shapes. The geometrical shapes are understood to be those shapes which form a cross-sectional area parallel to the area of the textile substrate. Thus, for instance, dots, triangles, squares, rectangles, hearts, stars or other geometrical shapes can be applied. Furthermore, the three-dimensional pattern can be designed in a regular manner, i.e. the different or identical geometrical shapes are applied regularly, i.e. in the form of a raster, on the textile substrate. An irregular arrangement of identical or different geometrical shapes, however, is also conceivable. Thus, the geometrical shapes can be irregularly distributed across the area of the textile substrate, so that they form e. g. a. figure and/or a brand or a manufacturer's mark becoming visible by the irregular arrangement and/or the use of different geometrical shapes.

However, advantageously the geometrical shapes are dots. In this connection, dots of a diameter ranging from 0.2 mm to 10 mm, especially preferred from 0.5 mm to 5 mm, especially from 1 mm to 2 mm, can be applied. The distance between the central points of the geometrical shapes and/or dots relative to each other advantageously is to lie between 1 to 10 mm, especially preferably between 2 mm and 5 mm. In addition, the distance between two dots (dot edges) is preferably 50% to 200%, especially preferably 50 to 90% of the dot diameter.

Due to said distance what may be achieved in a particularly efficient manner is that the textile substrate is sufficiently protected by the three-dimensional pattern and the abrasion resistance is improved accordingly. Due to the distance of the central points and the cross-sectional area of the geometrical shapes parallel to the area of the textile substrate the degree of covering is also determined.

The three-dimensional pattern, however, cannot only pertain to individual identical or different independent geometrical shapes but may also have a continuous structure. That is to say, it is applied on the textile substrate in a grid-like manner, for example. Also conceivable are lines running in parallel or transversely to an edge of the textile substrate.

The three-dimensional pattern usually consists of a plastic material, e.g. silicone, polyvinyl chloride, polyvinyl acetate, polyacrylate, vinyl acetate copolymer, vinyl chloride copolymer, (meth-)acrylate copolymer, whereby these copolymers can include any monomers as comonomers, preferably monomers which increase the degree of water solubility of the copolymer (e.g. vinyl alcohol) or are accessible to cross linking, or polyurethane as well as mixtures of at least two of these (co-) polymers, whereby polyvinyl acetate, vinyl acetate copolymer, and polyurethane as well as mixtures of at least two of these (co-) polymers are preferred. The (co-) polymers used can preferably be dispersed in water. The dispersions are preferred to be highly viscous and have a solids content of 50 to 80 weight percent, in particular 65 to 75 weight percent.

For the production of a three-dimensional pattern made of polyurethane there is used a polyurethane dispersion, in particular a dispersion of an ionomeric (anionic) polyurethane on water basis, which is dried after application. In this connection, the term “polyurethane” also covers polyurethane polyureas. A survey of polyurethane (PUR) dispersions can be found in “Rosthauser und Nachtkamp, Waterborne Polyurethanes, Advances in Urethane Science and Technology, vol. 10, pp. 121-162 (1987)”. Suitable dispersions, for example, are also described in “Kunststoffhandbuch”, vol. 7, 2^{nd} edition, Hanser, pp. 24-26.

The dispersions and/or pastes used in accordance with the invention are furthermore preferably thixotrope. The viscosity of the dispersions and/or pastes used preferably decreases in the case of constant shear strain and increasing test duration.

The quiescent viscosity (viscosity measured without any previous application of shearing forces) of the dispersion preferably amounts to 120 to 300 poise, in particular 200 to 290 poise (viscosities measured according to Brookfield at 25° C.; spindle 2; 20 revolutions per minute).

Dispersions preferably used in accordance with the invention include Tubicoat AS60 and Tubicoat AS65 (producer/supplier: CHT R. Beitlich GmbH, Tübingen).

To adjust the viscosity of the dispersion used thickening agents can be used. Suitable thickening agents are thickeners such as polyacrylic acids, polyvinyl pyrrolidones, silicic acids, betonites, kaolins and/or alginic acids. For example, the thickening agent Tubicoat Verdicker DAE can be used (producer/supplier: CHT R. Beitlich GmbH, Tübingen).

In addition, the dispersion usually contains pigments. Pigments used in the invention are described in Ullmann's Encyclopedia of Industrial Chemistry, 5^{th} ed., 1992, vol. A20, pages 243 to 413. The pigments used in the invention may be inorganic or organic pigments. The light-fastness of the pigments used should preferably be as high as possible and is preferably in the range of the light-fastness of the pigments Bezaprint, e.g. Bezaprint Gelb RR (yellow), Bezaprint Gelb 6G (yellow), Bezaprint Grün B (green), Bezaprint Rosa BW (pink), Bezaprint Braun TT (brown), Bezaprint Violett FB (purple), Bezaprint Rot KGC (red), Bezaprint Blau BT (blue), Bezaprint Blau B2G (blue) Bezaprint Schwarz DW (black), Bezaprint Grün BT (green) (all available from Bezema AG, Montlingen, Switzerland), PIGMATEX Gelb (yellow) 2 GNA (60456), PIGMATEX Gelb (yellow) K (60455), PIGMATEX Fuchsia BW (60416), PIGMATEX Marine (navy blue) RN (60434), PIGMATEX Braun (brown) R (60446), PIGMATEX Schwarz (black) T (60402) (all available from SUNChemical, Bad Honnef, Germany); Ocker (ochre) E.M.B (Ref. 3500), Rot-Violett (red-purple) E.M.B. (Ref. 4406), Braun (brown) E.M.B. (Ref. 5550) and Blau (blue) E.M.B. (Ref.

6500) (all available from EMB NR, Bronheim, Belgium) which are particularly preferred in the invention. The light-fastness values are preferably at least 6, especially preferably at least 7 (blue scale; 1 g/kg, see DIN 75 202). The amount of pigments used depends on the intended depth of the colour and is not particularly limited. Preferably, the pigment is used in an amount of up to 10 wt.-% based on the total weight of the dispersion, especially preferably in an amount of 0.1 to 5 wt.-% in the case of light colours such as e.g. yellow, and in an amount of 5 to 10 wt.-% in the case of dark colours such as e.g. black or blue.

The dispersion can further contain a cross linking agent and/or fixing agent to increase the hardness of the three-dimensional pattern. Fixing agents preferred for the invention are amino resins or phenolic resins. Suitable amino resins or phenolic resins are the well-known commercial products (cf. “Ullmanns Enzyklopädie der technischen Chemie”, vol. 7, 4^{th} edition, 1974, pages 403 to 422, and “Ullmann's Encyclopedia of Industrial Chemistry, vol. A19, 5^{th} ed., 1991, pages 371 to 384).

The melamine-formaldehyde resins are preferred, replacement of 20 mol-% of the melamine with equivalent amounts of urea being possible. Methylolated melamine is preferred, for example, bi-, tri- and/or tetramethylol melamine.

The melamine-formaldehyde resins are generally used in powder form or in the form of their concentrated aqueous solutions which have a solids content of 40 to 70 wt.-%. For example, Tubicoat Fixierer (fixing agent) HT or Tubicoat Fixierer (fixing agent) R (all available from CHT R. Beitlich GmbH, Tübingen) may be used.

Alternatively, fixing agents may be aliphatic or aromatic isocyanates, which may optionally be blocked, as well as polyaziridine.

The fixing agent is preferably used in an amount of 0 to 60 parts per 1000 parts of the dispersion.

Furthermore, the dispersion can contain ammonia and flame retardants.

Suitable flame retardants are e.g. antimony trioxide Sb₂O₃, antimony pentoxide Sb₃O₃, alumina hydrate Al₂O₃ .3H₂O, zinc borate Zn(BO₂)₂.2H₂O or 2ZnO.(B₂O₃)₃.(H₂O)_{3,5}, ammonium ortho- or polyphosphate NH₄H₂PO₄ or (NH₄PO₃)ₙ and chloroparaffines.

Especially preferred are the phosphonic acid esters, particularly 5-ethyl-2-methyl-1,3,2-dioxaphosphorinane-5-yl) methyl phosphonate-P-oxide and bis(5-ethyl-2-methyl-1,3,2-dioxaphosphorinane-5-yl)methyl methyl phosphonate-P,P′-dioxide, decabromodiphenylether, hexabromocyclodecane and polyphosphonates such as the product Apirol PP 46 of CHT R. Beitlich GmbH, Tübingen, which is preferably used in an amount of 150 to 250 parts, especially preferably 170 to 190 parts per 1000 parts of the total dispersion.

The dispersion used according to the invention may also contain sun screens.

Sun screens such as bis(1,2,2,6,6-pentamethyl-4-piperidyl) sebacate and methyl-1,2,2,6,6-pentamethyl-4-piperidyl sebacate, UV absorbers and sterically hindered phenols may also be included in the composition used according to the invention.

It constitutes an advantage that the three-dimensional pattern regenerates after deformation due to the application of a force. The application of a force in this context means a weight corresponding to approx. 350 kg, preferably up to 480 kg per square meter, such as is exerted, for example, by a person sitting on a seat or by a piece of luggage placed in the trunk of a motor vehicle.

The three-dimensional pattern on the textile substrate preferably has a height in the range of 0.1 mm to 5 mm, especially preferably in a range of 0.3 to 3 mm and most preferably in the range of 1 to 2 mm. The upper limit of 5 mm follows from the marginal conditions of the production and in this connection in particular from the quality of the stencil used in a rotary screen printing method for the application of the three-dimensional pattern, such as will be described below. The height also defines the degree of three-dimensionality and/or of the volume, as mentioned in the above.

Preferably after the application of the three-dimensional pattern, after 50.000 Martindale abrasion cycles the textile product according to the invention shows a mass loss of preferably less than 0.03 g, especially preferably less than 0.02 g, most preferably less than 0.01 g (per textile sample; according to DIN EN ISO 12947-3).

In addition, after application of the three-dimensional pattern preferably no destruction of the sample is observed after 50.000 Martindale abrasion cycles (determined according to DIN EN ISO 12947-2 (December 1998)).

In addition, after application of the three-dimensional pattern no pilling is preferably observed on the sample after 50.000 Martindale abrasion cycles.

After 50.000 Martindale abrasion cycles the textile product according to the invention preferably shows a mass loss of less than 0.03 g, especially preferably less than 0.02 g, most preferably less than 0.01 g (per textile sample; according to DIN EN ISO 12947-3). In addition, the textile product according to the invention shows neither any destruction (determined according to DIN EN ISO 12947-2 (December 1998)) nor any pilling.

In an especially preferred embodiment the invention provides a textile product, comprising
a textile substrate which after 50.000 Martindale abrasion cycles shows a mass loss of more than 0.03 g and/or a destruction and/or pilling;
a three-dimensional pattern made of polyurethane and/or polyvinyl acetate applied on the textile substrate, whereby
the three-dimensional pattern covers at least 30% of the area of the textile substrate, and
the textile product shows a mass loss of less than 0.02 g, no destruction and no pilling after 50.000 Martindale abrasion cycles.

The textile products according to the invention can be produced by a process comprising the following steps: Providing a textile substrate web having a certain abrasion resistance, such as described in the above already; and applying a three-dimensional pattern on the textile substrate web covering at least 15% of the area of the textile web, so that the abrasion resistance of the textile product is beyond that of the substrate web. In other words, the textile substrate is provided in the form of a web and, as described in the above, similarly comprises a certain abrasion resistance which can be ascertained according to the Martindale process. Subsequently, a three-dimensional pattern is applied on said web, so that at least 15% of the textile substrate web is covered by the three-dimensional pattern. Preferably 25% of the area is covered and most preferably 30 to 40%. Especially preferred embodiments of the three-dimensional pattern are described in the above.

To apply the three-dimensional pattern, for example, a screen printing method comprising a rotary screen printing machine can be used. In this connection, the mass to be applied is transferred onto the textile substrate by means of a squeegee, preferably a closed squeegee, through a stencil having a pattern that corresponds to the three-dimensional pattern. The coating process preferably takes place with a Stork Rotary Screen Coating UNIT CFT (Stork Brabant B. V., Boxmeer, Netherlands). The stencil used in the rotary screen printing method can be a chromium-nickel stencil, however, plastic stencils are preferred, in particular those made of polyamide or polyester. Plastic stencils of said type can especially be produced in an easier and more precise manner and are preferred for this reason.

The three-dimensional pattern is advantageously applied by means of applying a polyurethane and/or polyvinyl acetate (and/or vinyl acetate copolymer) mass. In this connection, the mass preferably has free-flowing, thixotrope qualities. The squeegee pressure (which is determined by the system pressure, which is preferably 0.5 to 5.7 bar, especially preferably about 2.5 bar), the position of the squeegee and the rate of rotation are adjusted in such a way that the paste is free-flowing.

The stencil is designed in accordance with the desired three-dimensional pattern. That is to say, for example, a hole pattern with holes of the same and/or different diameters of between 0.5 mm and 5 mm can be provided, the stencil having a size of between 0.5 mm and 5 mm. With the help of such a stencil the three-dimensional pattern can be applied as a dot pattern of the same and/or different diameters, whereby after application the dots may still spread a little bit depending on the viscosity of the mass, so that the height is somewhat reduced and the diameters get somewhat larger.

After application of the mass, i.e. of the three-dimensional pattern, the substrate web is dried at a temperature of between 80 to 180°. Another process step comprises the additional tentering of the substrate web on a tenter frame of between about 140 and 1900 Celsius, as well as the cutting and/or stretching of the textile substrate web to its final size. The final product obtained in this manner, i.e. the textile product then shows qualities such as were described in the above in connection with the textile product. That is to say, an abrasion resistance could be reached, which lies beyond the initial abrasion resistance of the textile substrate.

As a consequence, such a textile product can be used in the fields of interior lining of motor vehicles or as seat cover, in particular in fields that are subject to correspondingly high requirements with respect to the abrasion resistance, whereby a relatively favorable substrate base material easy to produce can be used, the abrasion resistance of which can be improved by means of applying the three-dimensional pattern in such a manner that a textile product is produced, which complies with the high requirements made in the above-mentioned fields. The textile product may e.g. be laminated onto a substrate made of wood or synthetic material, it may be used in the trunk as a padding or, laminated onto a non-woven or a foamed material, used as a seat cover.

### SHORT DESCRIPTION OF THE DRAWINGS

Preferred embodiments of the inventions will be described below on the basis of the accompanying drawings, in which

FIG. 1 shows a textile product having a uniform, punctiform pattern,

FIG. 2 shows a textile product having a continuous pattern across the textile substrate web,

FIG. 3 shows a non-uniform pattern having different geometrical shapes of different areas,

FIG. 4 shows the textile product from FIG. 1 in a side view, and

FIG. 5 shows the application of the three-dimensional pattern on the textile substrate by means of a rotary screen printing method.

### DESCRIPTION OF THE DRAWINGS

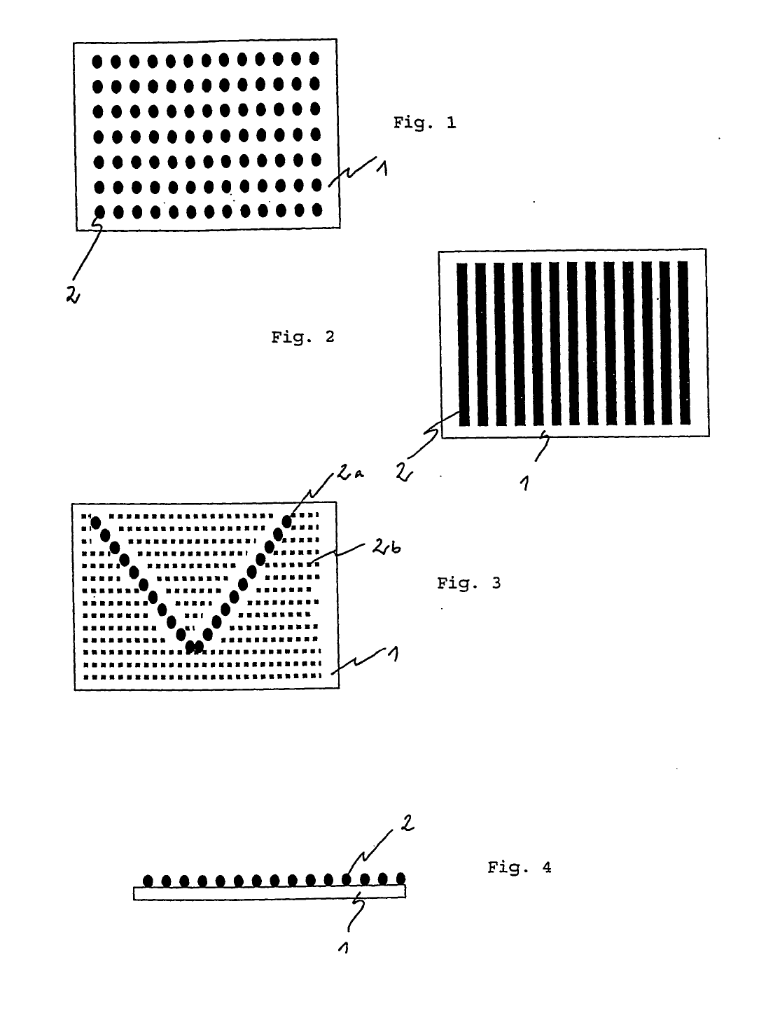

The textile products shown in FIGS. 1 to 3 are a textile substrate having an applied three-dimensional pattern. In this connection, FIG. 1 shows a uniform arrangement of punctiform elevations 2 applied on the textile substrate 1. The distances between the dots 2 and/or elevations are uniformly designed across the area of the textile substrate, so that as a result at least 30% of the area is covered. FIG. 2, on the other hand, shows the three-dimensional pattern 2 sort of in the form of stripes running transversely across an edge of the textile substrate 1 across it. It is a continuous pattern for this reason. The stripes could just as well run in another direction or diagonally across the textile substrate 1. Furthermore, a grid structure is also conceivable. As shown in FIG. 3, different geometrical shapes can also form the three-dimensional pattern. Thus, for instance, dots of a large diameter may be combined with dots of a small diameter or, as shown, different geometrical shapes may be combined with one another. In this connection, for example, geometrical shapes may be combined, so that they form the brand or logotype of a company. For example, punctiform elevations 2a can be combined with squares 2b of a smaller size, so that the arrangement of the larger-sized dots 2a distinguishes itself from the arrangement of the squares 2b and thus constitutes a V.

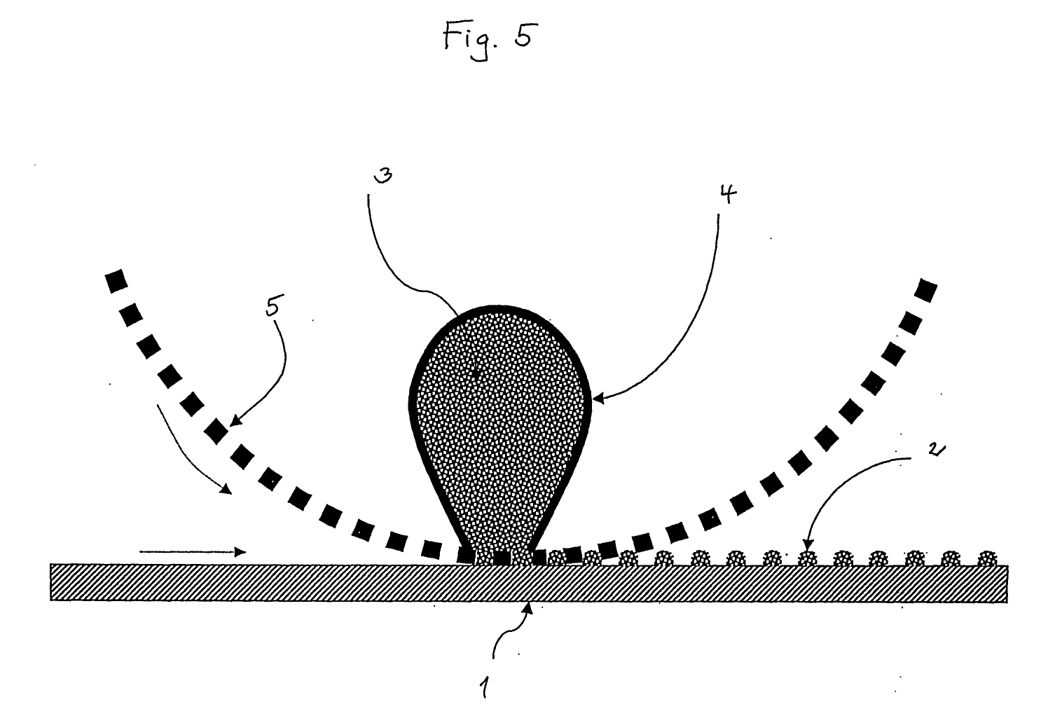

FIG. 4 shows a side view of the textile substrate 1 having the three-dimensional pattern from FIG. 1. In this connection, it can be seen that the pattern is not only optically applied on the textile substrate but that it actually pertains to a three-dimensional pattern, as defined in the above. In this connection, the paste can also partially penetrate under the surface of the textile substrate.

As mentioned in the above, a three-dimensional pattern according to the invention is preferably applied by means of a rotary screen printing method. In this connection, a free-flowing, thixotrope mass 3 is applied on the textile substrate by means of a cylindrical stencil 5 provided with a predetermined hole pattern. The stencil has a pattern which corresponds to the three-dimensional pattern to be applied. A firmly fixed squeegee 4 passes the mass 3 through the rotating cylindrical stencil 5. Furthermore, as indicated in FIG. 5, the surface of the textile substrate 1 to be provided with the pattern is moved in the form of a textile substrate web tangentially to the circular cross-section of the stencil. The mass is preferred to be thixotrope, so that when being under pressure exerted by the squeegee it becomes free-flowing to such an extent that it can be applied through the aperture pattern of the stencil and onto the surface of the textile substrate web. When the mass has been applied on the textile substrate web 1, i.e. the pressure exerted by the squeegee no longer exists, then the viscosity of the mass regenerates so that running or spreading of the three-dimensional pattern 2 can mainly be prevented.

Upon application of the three-dimensional pattern on the substrate web the latter is passed on to a drying apparatus, in which the textile substrate web is dried at a temperature of between 80 and 180° Celsius. Moreover, further drying is carried out by further stretching of the textile substrate web on a tenter frame at a temperature of about between 150 and 1900 Celsius. Finally, the textile substrate web is cut to its final size, so that a textile product of an improved abrasion resistance is achieved.

Further, the invention provides products the abrasion resistance of which is not necessarily improved by the three-dimensional pattern which have however advantageous product characteristics such as e.g. good haptics and a good appearance, based on a polyurethane coating (preferred a polyurethane stable foam coating, as described above) between the woven, the warp-knitted fabric, the weft-knitted fabric, the non-woven or the Raschel good and the three-dimensional pattern.

### EXAMPLE

A textile substrate web made of a Lantor bonded fabric 385 137 and having a basis weight of 150 g per square meter, which is laminated on a 3.2 mm polyurethane foam, has a low abrasion resistance. According to Martindale (DIN EN ISO 12947-1 and 3) a mass loss of 0.013 g after 50.000 abrasion cycles as well as strong pilling are observed.

The following polyurethane paste was applied in a punctiform manner on the following textile substrate:

| | |
|---|---|
| Tubicoat AS60 | 950 parts |
| (available from CHT, Tubingen) | |
| Tubicoat Fixierer R(fixing agent) | 50 parts |
| (available from CHT, Tubingen) | |
| Bezaprint Schwarz DW (black) | 40 parts |
| (available from Bezema, Montlingen) | |

The paste was applied with a closed squeegee by means of a Stork Rotary Screen Coating UNIT CFT in three different patterns:

| | Distance to | | | | |
|---|---|---|---|---|---|
| | next dot in | Distance | | | |
| | the same | to next | | | |
| | row in | dot in | | | |
| | longitudinal | parallel | Distance | Dot | Area |
| | direction | row | of dot rows | Radius | Covered |
| Pattern A | 8.2 mm | 8.2 mm | 8.2 mm | 1 mm | 4.7% |
| Pattern B | 3.4 mm | 2.9 mm | 2.3 mm | 1 mm | 40.2% |
| Pattern C | 2.3 mm | 2.5 mm | 2.1 mm | 0.75 mm | 36.6% |

After that drying was carried out at 80 to 1100 Celsius in a dryer. Condensing was carried out on a tenter frame at 180° Celsius and the product was brought to its final width.

Subsequently, the patterns were subjected to a Martindale test: None of the patterns showed a mass loss after 50.000 Martindale abrasion cycles. Contrary to pattern A no pilling was observed in the case of patterns B and C.

1. A textile product comprising
a textile substrate having a certain abrasion resistance; and
a three-dimensional pattern applied on the textile substrate, whereby
the three-dimensional pattern covers at least 15% of the area of the textile substrate so that the abrasion resistance of the textile product lies above the abrasion resistance of the textile substrate.

2. A textile product according to claim 1, characterized in that the three-dimensional pattern covers 25% to 50% of the textile substrate.

3. A textile product according to claim 1 or 2, characterized in that the three-dimensional pattern consists of polyurethane, polyvinyl acetate and/or a vinyl acetate copolymer.

4. A textile product according to at least one of claims 1 to 3, characterized in that the mass loss of the textile substrate amounts to more than 0.03 g in an abrasion test after 50.000 Martindale abrasion cycles, and that the corresponding mass loss of the textile product lies below the mass loss of the textile substrate.

5. A textile product according to claim 4, characterized in that the corresponding mass loss of the textile product is less than 0.02 g.

6. A textile product according to at least one of claims 1 to 5, characterized in that the textile substrate shows destruction in an abrasion test after 50.000 Martindale abrasion cycles (DIN EN ISO 12947-2).

7. A textile product according to claim 6, characterized in that the textile product shows no destruction in an abrasion test after 50.000 Martindale abrasion cycles (according to DIN EN ISO 12947-2).

8. A textile product according to at least one of claims 1 to 7, characterized in that the textile substrate shows pilling in an abrasion test after 50.000 Martindale abrasion cycles.

9. A textile product according to claim 8, characterized in that the textile product shows no pilling in an abrasion test after 50.000 Martindale abrasion cycles.

10. A textile product according to one of the previous claims, characterized in that the three-dimensional pattern has a height in the range of 0.1 mm to 5 mm, preferably in the range of 0.3 mm to 3 mm and most preferably in the range of 1 to 2 mm.

11. A textile product according to at least one of the previous claims, characterized in that the three-dimensional pattern has a uniform or non-uniform arrangement of identical or different geometrical shapes.

12. A textile product according to claim 11, characterized in that the geometrical shapes are dots having the same or a different diameter in the range of 0.2 mm to 10.0 mm.

13. A textile product according to claim 11 or 12, characterized in that the distance of the central points of the geometrical shapes relative to one another corresponds to between 2 mm and 5 mm.

14. A textile product according to one of the previous claims 11 to 13, characterized in that the distance between two dots (dot edges) amounts to between 50% and 200% of the dot diameter.

15. A textile product according to one of claim 11 to 10, characterized in that the three-dimensional pattern has a continuous structure.

16. A textile product according to at least one of the previous claims, characterized in that the three-dimensional pattern regenerates to return to its original state after deformation due to the application of a force corresponding to 480 kg/m².

17. A textile product according to at least one of the previous claims, characterized in that the textile substrate has a basis weight of 50 g/m² to 500 g/m², preferably of 100 g/m² to 450 g/m².

18. A textile product according to at least one of the previous claims, characterized in that the textile substrate is a woven fabric, warp-knitted fabric, weft-knitted fabric, non-woven or Raschel good.

19. A textile product according to claim 18, characterized in that the textile substrate is flat.

20. A textile product according to any one of claims 1 to 17, characterized in that the textile substrate is a woven fabric, warp-knitted fabric, weft-knitted fabric, non-woven or Raschel good which has a polymer coating.

21. A textile product according to claim 20, characterized in that the polymer coating is a coating on the basis of polyurethane.

22. A process for the production of a textile product having an improved abrasion resistance, comprising the following steps of
providing a textile substrate web of a certain abrasion resistance; and
applying a three-dimensional pattern on the textile substrate web by covering at least 15% of the area of the textile substrate web, so that the abrasion resistance of the textile product is above that of the textile substrate web.

23. A process according to claim 22, characterized in that the three-dimensional pattern covers at least 25% to 50% of the textile substrate.

24. A process according to claim 22 or 23, characterized in that the three-dimensional pattern is applied by means of applying a polyurethane, polyvinyl acetate and/or vinyl acetate copolymer mass.

25. A process according to claim 24, characterized in that the mass has free-flowing, thixotope qualities.

26. A process according to at least one of claims 22 to 25, characterized in that the three-dimensional pattern is applied by means of a plastic stencil.

27. A process according to claim 26, characterized in that the stencil has a hole pattern with holes of the same or a different diameter of between 0.5 mm and 5 mm at a height of between 0.5 mm and 5 mm.

28. A process according to one of claims 26 or 27, characterized in that the stencil consists of polyamide or polyester.

29. A process according to at least one of claim 24 to 28, characterized in that the mass has a quiescent viscosity of between 120 to 300 poise.

30. A process according to at least one of claims 24 to 29, characterized in that the mass has a solids content in the range of 65% to 75%.

31. A process according to at least one of claims 22 to 30, characterized in that the process additionally comprises drying of the textile substrate web provided with the three-dimensional pattern at a temperature of between 80 to 180° C.

32. A process according to one of claims 22 to 31, characterized in that the process additionally comprises tentering of the textile substrate web on a tenter frame at a temperature of between 140 to 190° C. as well as cutting of the textile substrate web to its final size.

33. Use of a textile product according to claims 1 to 21 in the interior space or trunk of a motor vehicle, or as seat covers, in particular as seat middle web or seat sides.
